(19) United States
(12) Patent Application Publication
(10) Pub. No.: US 2011/0032309 A1
(43) Pub. Date: Feb. 10, 2011

(54) Inkjet head, method of manufacturing the same, and electrical connection device therefor

(75) Inventors: Chang Sung Park, Suwon (KR); Jae Woo Joung, Suwon (KR); Jae Sung Kim, Suwon (KR); Ju Hwan Yang, Suwon (KR); Yoon Sok Park, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/654,434

(22) Filed: Dec. 18, 2009

(30) Foreign Application Priority Data
Aug. 4, 2009 (KR) 10-2009-0071754

(51) Int. Cl. B41J 2/16; B41J 2/045; H04R 17/00

(52) U.S. Cl. 347/50; 347/71; 29/25.35

(57) ABSTRACT

An inkjet head according to an aspect of the invention may include: an inkjet head body having an ink chamber provided therein and an electrode portion provided on a surface thereof adjacent to the ink chamber; a piezoelectric actuator being mounted on the surface of the inkjet head body so that the piezoelectric actuator is electrically connected to the electrode portion; and a substrate being pressed using a bonding tool so that the substrate is electrically connected to the electrode portion and the piezoelectric actuator, arranged in different planes, through a conductive adhesive.

### CROSS-REFERENCE TO RELATED APPLICATIONS

This application claims the priority of Korean Patent Application No. 10-2009-0071754 filed on Aug. 4, 2009, in the Korean Intellectual Property Office, the disclosure of which is incorporated herein by reference.

### BACKGROUND OF THE INVENTION

1. Field of the Invention

The present invention relates to an inkjet head, a method of manufacturing the same, and an electric connection device therefor, and more particularly, to an inkjet head that facilitates an electrical connection, a method of manufacturing the same, and an electric connection device therefor that electrically connects an actuator to an inkjet head body.

2. Description of the Related Art

In general, an inkjet head converts an electric signal into a physical force so that ink droplets are ejected through small nozzles.

In recent years, piezoelectric inkjet heads have been used in industrial inkjet printers. For example, a circuit pattern is directly formed by spraying ink prepared by melting metals such as gold or silver onto a printed circuit board (PCB). A piezoelectric inkjet head is also used for industrial graphics, and is used in the manufacturing of a liquid crystal display (LCD) and an organic light emitting diode (OLED).

An inlet and an outlet through which ink is introduced and ejected in a cartridge, a reservoir storing the ink being introduced, and chambers through which a driving force of an actuator by which the ink in the reservoir is moved to nozzles are provided in an inkjet head of an inkjet printer.

An actuator is connected to an inkjet head in the related art by wire bonding between an upper electrode of the actuator and an electrode of a substrate. As the number of nozzles in one inkjet head increases, performing wire bonding for the connection of the actuator becomes time-consuming.

In addition to wire bonding, by which the actuator is electrically connected to the inkjet head in the related art, the actuator may be electrically connected to the inkjet head by a separate soldering process. However, the soldering process is also time-consuming. There is a need for techniques to solve these problems.

### SUMMARY OF THE INVENTION

An aspect of the present invention provides an inkjet head that can electrically connect an actuator to an inkjet head body with ease using a one-step process, a method of manufacturing the inkjet head, and an electrical connection device for an inkjet head that electrically connects a piezoelectric actuator to the inkjet head body.

According to an aspect of the present invention, there is provided an inkjet head including: an inkjet head body having an ink chamber provided therein and an electrode portion provided on a surface thereof adjacent to the ink chamber; a piezoelectric actuator being mounted on the surface of the inkjet head body so that the piezoelectric actuator is electrically connected to the electrode portion; and a substrate being pressed using a bonding tool so that the substrate is electrically connected to the electrode portion and the piezoelectric actuator, arranged in different planes, through a conductive adhesive.

The conductive adhesive may be arranged between the piezoelectric actuator and the substrate and has bent ends making contact with edges of the piezoelectric actuator when the conductive adhesive is pressed at the same time as the substrate is pressed using the bonding tool.

The substrate may include an actuator connection portion electrically connected to one side of the piezoelectric actuator whose other side makes contact with the electrode portion, and electrode connection portions electrically connected to the electrode portion.

The actuator connection portion and the electrode connection portions of the substrate may be separated from each other.

The substrate may completely cover a surface of the piezoelectric actuator.

The substrate may partially cover a surface of the piezoelectric actuator.

According to another aspect of the present invention, there is provided a method of manufacturing an inkjet head, the method including: arranging an inkjet head body having an electrode portion on a stage; arranging a piezoelectric actuator on the inkjet head body so that the piezoelectric actuator and the inkjet head body are electrically connected to each other, and arranging the substrate on the piezoelectric actuator; and pressing the substrate by moving the bonding tool so that the substrate is electrically connected to the piezoelectric actuator and the electrode portion.

The pressing of the substrate may include arranging the conductive adhesive under the substrate such that the conductive adhesive is bent in contact with the piezoelectric actuator along the surface thereof.

The method may further include arranging a damper between the substrate and the bonding tool.

A film type adhesive may be used as the conductive adhesive.

According to another aspect of the present invention, there is provided an electrical connection device for an inkjet head, the electrical connection device including: a stage in which an inkjet head body, having an electrode portion electrically connected with a piezoelectric actuator, is arranged; and a bonding tool located above the stage and pressing the conductive adhesive and the substrate into close contact with the electrode portion and the piezoelectric actuator arranged in different planes.

The bonding tool may further include a damper arranged between the conductive adhesive and the bonding tool.

The damper may be provided integrally with the bonding tool.

The damper may be separated from the bonding tool.

The bonding tool may include bent portions moving along edges of the piezoelectric actuator.

The stage may include stoppers to secure the inkjet head body received therein.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an inkjet head according to an exemplary embodiment of the present invention;

FIG. 2 is a cross-sectional view illustrating the inkjet head of FIG. 1;

FIG. 3 is a top view illustrating the inkjet head of FIG. 1;

FIGS. 4 and 5 are side sectional views illustrating the inkjet head of FIG. 3;

FIG. 6 is an exploded sectional view illustrating the operation of an electrical connection device for an inkjet head according to an exemplary embodiment of the present invention;

FIG. 7 is a partial sectional view illustrating the operation of the electrical connection device for an inkjet head of FIG. 6;

FIG. 8 is a schematic sectional view illustrating an inkjet head completed by the electrical connection device for an inkjet head of FIG. 6;

FIG. 9 is a top view illustrating an inkjet head according to another exemplary embodiment of the present invention; and

FIG. 10 is a cross-sectional view illustrating the inkjet head of FIG. 9.

### DETAILED DESCRIPTION OF THE PREFERRED EMBODIMENT

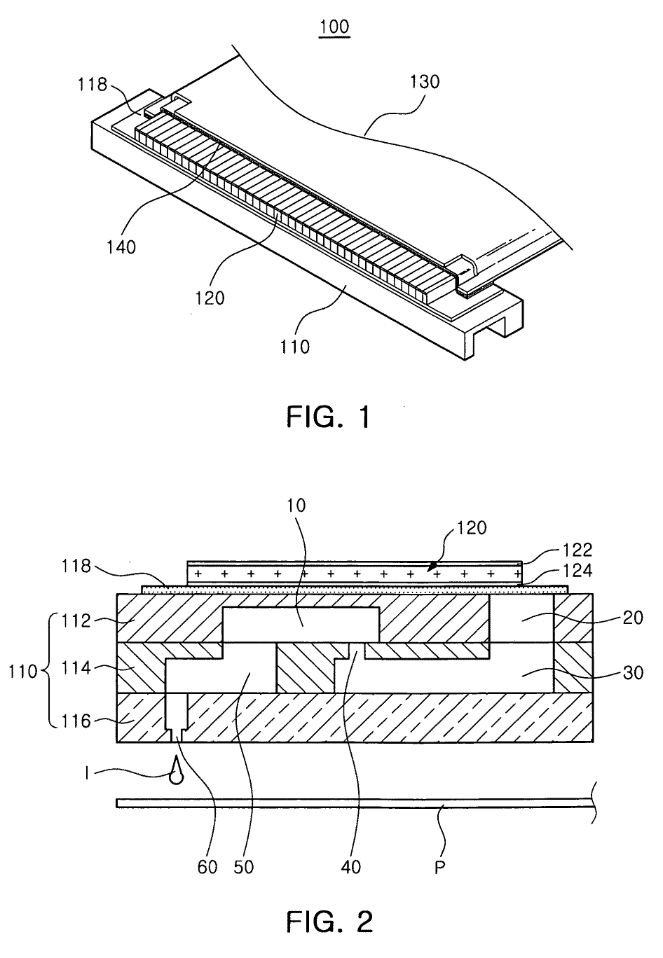

An inkjet head, a method of manufacturing the same, and an electrical connection therefor will be described in detail with reference to FIGS. 1 through 8. Exemplary embodiments of the present invention will now be described in detail with reference to the accompanying drawings.

The invention may, however, be embodied in many different forms and should not be construed as limited to the embodiments set forth herein. Rather, these embodiments are provided so that this disclosure will be thorough and complete, and will fully convey the scope of the invention to those skilled in the art.

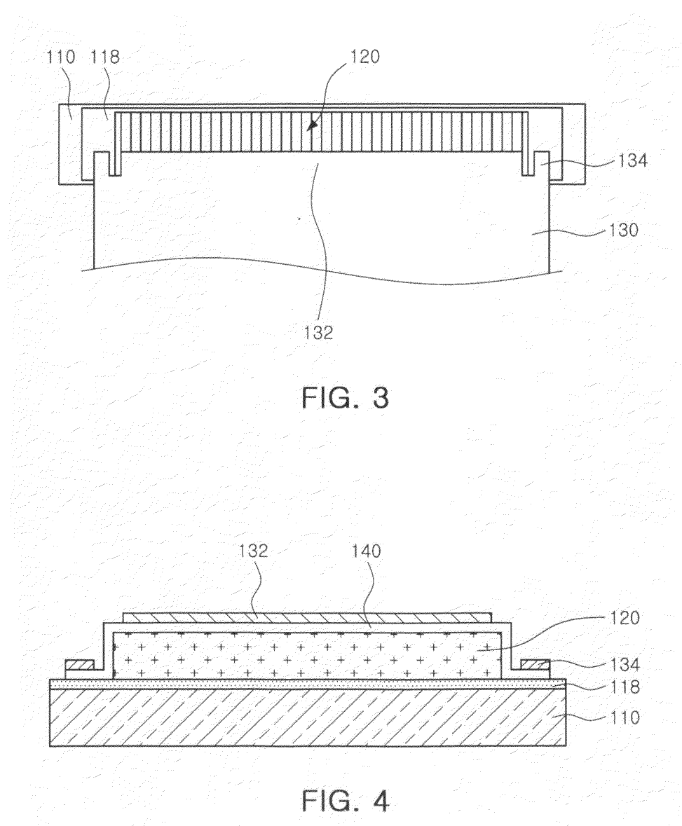

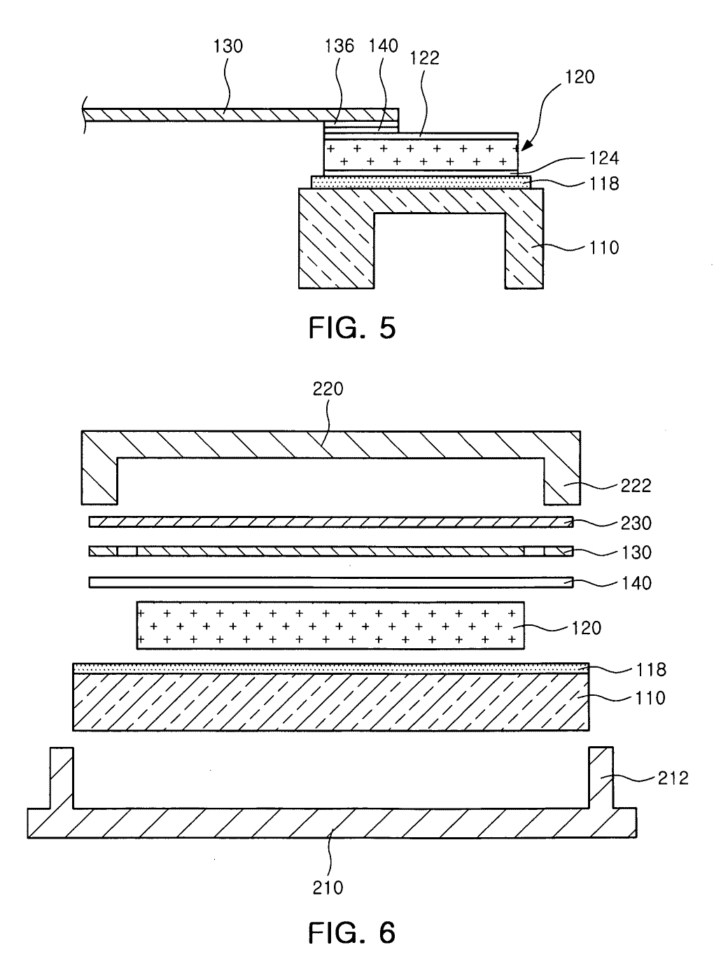

FIG. 1 is a schematic perspective view illustrating an inkjet head according to an exemplary embodiment of the invention. FIG. 2 is a cross-sectional view illustrating the inkjet head of FIG. 1. FIG. 3 is a top view illustrating the inkjet head of FIG. 1. FIGS. 4 and 5 are side sectional views illustrating the inkjet head of FIG. 3.

Referring to FIGS. 1 through 5, an inkjet head 100 according to this embodiment may include an inkjet head body 110, a piezoelectric actuator 120, a substrate 130 and a conductive adhesive 140.

As shown in FIG. 2, the inkjet head body 110 ejects ink to the outside by the driving of the piezoelectric actuator 120. Here, the inkjet head body 110 may include a flow path plate 112, an intermediate plate 114 and a nozzle plate 116.

The flow path plate 112 includes a plurality of ink chambers 10 and an ink introduction hole 20 through which ink is introduced. Here, the ink introduction hole 20 is directly connected to a manifold 30. The manifold 30 supplies ink to the ink chambers 10 with a restrictor 40.

The ink chambers 10 are provided at positions located under the piezoelectric actuator 120. Here, a portion of the flow path plate 112 that forms the ceiling of the ink chambers 10 serves as a vibration plate.

Therefore, when a driving signal is applied to the piezoelectric actuator 120 in order to eject ink, the piezoelectric actuator 120 and the vibration plate thereunder are deformed to reduce the volumes of the ink chambers 10.

The reduction in the volumes of the ink chambers 10 increases the pressure inside the ink chambers 10, so that ink I inside the ink chambers 10 may be ejected to the outside through dampers 50 and nozzles 60 and be printed on paper P.

The intermediate plate 114 may include the manifold 30 extending in a longitudinal direction and the dampers 50 connecting the nozzles 60 and the ink chambers 10.

The manifold 30 receives ink through the ink introduction hole 20 and supplies the received ink to the ink chambers 10. The manifold 30 and the ink chambers 10 are connected to each other through the restrictor 40.

Here, the manifold 30 may be one big space to which the plurality of ink chambers 10 are connected. However, the invention is not limited thereto, and a plurality of manifolds may be formed to correspond to the individual ink chambers 10.

The dampers 50 receive the ink being ejected from the ink chambers 10 by the piezoelectric actuator 120 and eject the received ink to the outside through the nozzles 60.

Here, the dampers 50 are optional. When the dampers 50 are removed, the inkjet head may only include the flow path plate 112 and the nozzle plate 116.

The nozzle plate 116 corresponds to the ink chambers 10. The ink passing through the dampers 50 is ejected to the outside through the nozzles 60. The nozzle plate 116 is bonded to the bottom of the intermediate plate 114.

The ink moving through a flow path formed inside the inkjet head is sprayed as ink droplets through the nozzles 60.

Here, silicon substrates being widely used for semiconductor integrated circuits may be used as the flow path plate 112, the intermediate plate 114 and the nozzle plate 116.

Electrodes electrically connected to each other may be formed on upper and lower surfaces of the piezoelectric actuator 120. The electrodes may be formed of Lead Zirconate Titanate (PZT) ceramics, which is one of piezoelectric materials.

Here, the piezoelectric actuator 120 may be formed in a bulk shape. As shown in FIG. 1, cutting lines may be formed in the piezoelectric actuator 120 in the bulk shape.

An upper electrode 122 may be formed on the upper surface of the piezoelectric actuator 120 so as to be electrically connected to the substrate 130. A lower electrode 124 may be formed on the lower surface of the piezoelectric actuator 120 so as to be electrically connected to an electrode portion 118 that is formed on the surface of the inkjet head body 110 and serves as a ground.

Here, electrode materials may be deposited over the piezoelectric actuator 120 to thereby form the lower electrode 124. However, the method of forming the lower electrode 124 is not limited thereto.

Furthermore, as shown in FIGS. 3 and 4, the substrate 130 may include an actuator connection portion 132 and electrode connection portions 134. The actuator connection portion 132 is connected to the upper electrode 122 in order to supply power to the piezoelectric actuator 120. The electrode connection portions 134 are electrically connected to the surface of the electrode portion 118 formed on the inkjet head body 110.

The substrate 130 may be arranged on the end of the edge of the piezoelectric actuator 120. However, the arrangement of the substrate 130 is not limited thereto.

Here, the actuator connection portion 132 and the electrode connection portions 134 may be spaced apart from each other. Therefore, even though the upper electrode 122 and the electrode portion 118 are arranged in different planes, the electrical connection of the substrate 130 can be facilitated because of the structure in which the actuator connection portion 132 and the electrode connection portions 134 are separated from each other.

As shown in FIG. 5, pad portions 136 are formed on the bottom of the actuator connection portion 132 so as to be electrically connected to the piezoelectric actuator 120 through the conductive adhesive 140.

The conductive adhesive 140 may be arranged between the piezoelectric actuator 120 and the substrate 130 and have bent ends such that the conductive adhesive 140 makes close contact with the piezoelectric actuator 120 along the surface of the piezoelectric actuator 120 when the substrate 130 is pressed using a bonding tool.

Here, the conductive adhesive 140 may be a film type adhesive such as an Anisotropic Conductive Film (ACF).

As shown in FIG. 4, the ends of the conductive adhesive 140 may be bent such that the conductive adhesive 140 makes contact with the surface and edges of the piezoelectric actuator 120. Therefore, since the conductive adhesive 140 completely covers the piezoelectric actuator 120, thereby protecting the piezoelectric actuator 120 against external shocks. Furthermore, the effects of vibrations from the piezoelectric actuator 120 being transmitted to the inkjet head body 110 can be maximized to thereby increase the reliability of the inkjet head.

In this embodiment, since the conductive adhesive 140 and the substrate 130 are pressed using the bonding tool at the same time, the substrate 130 is electrically connected to the piezoelectric actuator 120 and the electrode portion 118 through the conductive adhesive 140. Therefore, a plurality of processes are unnecessary, thereby manufacturing the inkjet head with remarkable ease and simplifying the manufacturing process.

In addition, electrical bonding failures that may occur during the electrical connection process of the piezoelectric actuator 120 using wire bonding can be reduced.

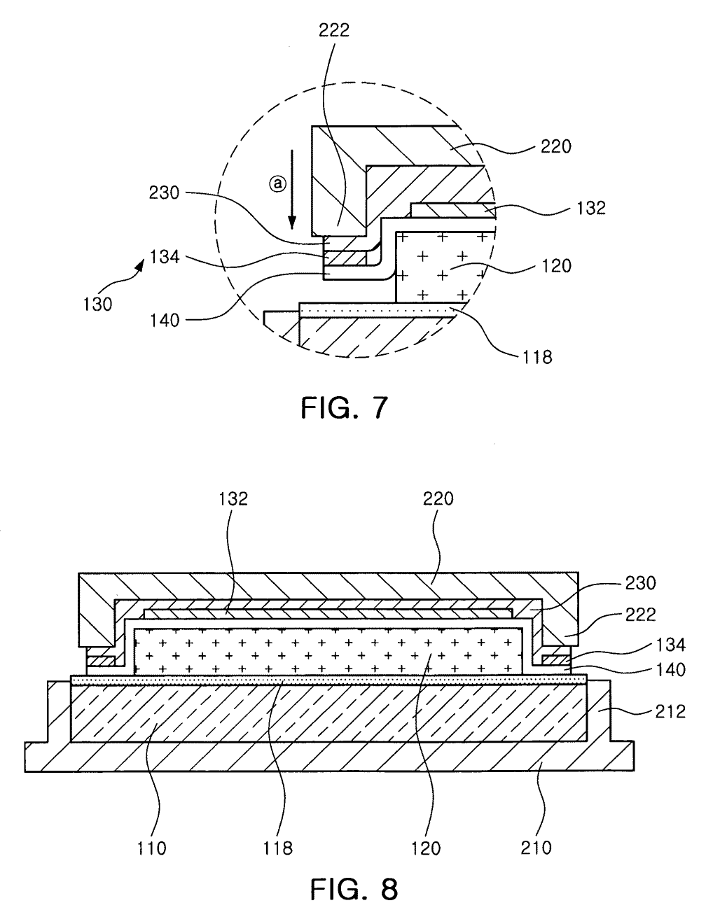

FIG. 6 is an exploded cross-sectional view illustrating an electrical connection device for an inkjet head according to an exemplary embodiment of the invention. FIG. 7 is a partial sectional view illustrating the operation of the electrical connection device for an inkjet head of FIG. 6. FIG. 8 is a schematic sectional view illustrating an inkjet head completed by the electrical connection device for an inkjet head of FIG. 6.

Referring to FIGS. 6 through 8, an electrical connection device for an inkjet head according to this embodiment may include a stage 210 and a bonding tool 220.

The stage 210 may have a cavity in which the inkjet head body 110 having the electrode portion 118 thereupon is arranged, and may include stoppers 212 corresponding to both ends of the inkjet head body 110. Here, the stoppers 212 are separated from each other by a distance as long as the inkjet head body 110 in order to prevent the movement of the inkjet head body 110.

Therefore, the stage 210, located under the inkjet head body 110, supports the inkjet head body 110 being pressed using the bonding tool 220, so that the conductive adhesive 140 can be easily attached to the inkjet head body 110.

The bonding tool 220 is arranged on the inkjet head body 110, the piezoelectric actuator 120, the conductive adhesive 140 and the substrate 130, which are formed on the stage 210 in a sequential manner. Further, the bonding tool 220 can be moved in a vertical direction.

The bonding tool 220 includes bent portions 222 formed at both ends thereof that are bent downwards at right angles.

Since the bent portions 222 move along the edges of the piezoelectric actuator 120, the conductive adhesive 140 completely covers the piezoelectric actuator 120 by being pressed using the bonding tool 220.

A space created between the bent portions 222 may correspond to the length of the piezoelectric actuator 120. Therefore, the inside of the bonding tool 220 makes contact with the upper surface of the piezoelectric actuator 120, and the surfaces of the bent portions 222 make contact with the surface of the electrode portion 118.

An elastic sheet 230 may be arranged between the bonding tool 220 and the substrate 130. When the substrate 30 is pressed using the bonding tool 220, the elastic sheet 230 can prevent damage to the substrate 130 and the other components.

A method of manufacturing an inkjet head according to an exemplary embodiment of the invention will now be described.

According to the method of manufacturing an inkjet head, the inkjet head body 110 is arranged in the stage 210, and the conductive adhesive 140 is arranged on the piezoelectric actuator 120.

Here, since the stage 210 includes the stoppers 212 formed to correspond to both ends of the inkjet head body 110 in order to prevent the movement of the inkjet head body 110, the inkjet head body 110 can be easily arranged in the space created by the stoppers 212.

The piezoelectric actuator 120 may be then electrically connected to the inkjet head body 110 having the electrode portion 118 formed thereon.

Here, the lower electrode 124 of the piezoelectric actuator 120 is bonded to the electrode portion 118 so that the lower electrode 124 and the electrode portion 118 are electrically connected with each other. Epoxy may be used as an adhesive in the bonding process. However, the invention is not limited thereto.

The adhesive may have a small thickness of 2 to 5 μm. When the thickness of the adhesive becomes smaller or larger, electrical loss may be caused or mechanical reliability may be deteriorated. Therefore, the adhesive is applied at the above thickness.

The conductive adhesive 140 is then pressed using the bonding tool 220 so that the conductive adhesive 140 makes contact with the piezoelectric actuator 120 along the surface thereof.

Specifically, as shown in FIGS. 7 and 8, when the bonding tool 220 moves down \textcircled{a}, since the bent portions 222 of the bonding tool 220 make close contact with the edges of the piezoelectric actuator 120, the conductive adhesive 140 is bonded to the piezoelectric actuator 120 so as to completely seal the piezoelectric actuator 120.

The upper electrode 122 of the piezoelectric actuator 120 makes contact with the space created between the bent portions 222 of the bonding tool 220. The electrode connection portions 134, pressed against the bent portions 222, make contact with the electrode portion 118 arranged at a lower level than the upper electrode 122.

Therefore, the electrical connection device for an inkjet head according to this embodiment can easily finish forming the electrical connection of the inkjet head because the actuator connection portion 132 and the electrode connection portions 134 can be electrically connected to the upper electrode 122 and the electrode portion 118 arranged in different planes, respectively, at the same time, using the bonding tool 220, thereby simplifying the manufacturing process.

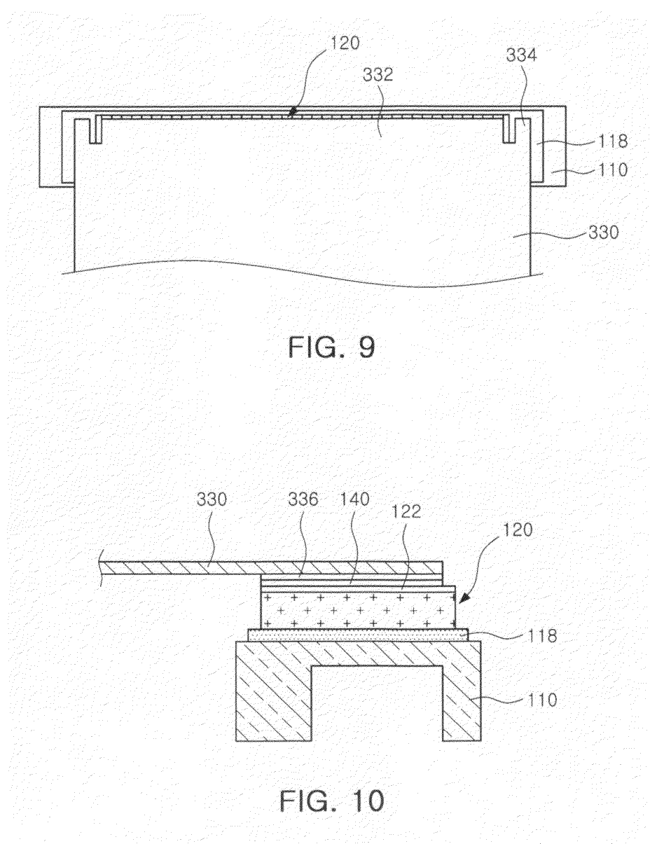

FIG. 9 is a top view illustrating an inkjet head according to another exemplary embodiment of the invention. FIG. 10 is a cross-sectional view illustrating the inkjet head of FIG. 9.

Referring to FIGS. 9 and 10, an inkjet head 300 according to this embodiment may include the inkjet head body 110, the piezoelectric actuator 120, the substrate 330 and the conductive adhesive 140.

Here, since the configurations of the inkjet head body 110, the piezoelectric actuator 120 and the conductive adhesive 140 are substantially the same as those of the embodiment described with reference to FIGS. 1 through FIG. 5, a detailed description thereof may be omitted.

The substrate 330 may include an actuator connection portion 332 and electrode connection portions 334. The actuator connection portion 332 is connected to the upper electrode 122 in order to supply power to the piezoelectric actuator 120. The electrode connection portions 334 are electrically connected to the electrode portion 118 formed on the surface of the inkjet head body 110. Here, as shown in FIG. 10, the electrode connection portions 334 include pad portions 336. Since the entirety of pad portions 336 make contact with the upper electrode 122, thereby forming an electrical connection.

Therefore, since the substrate 330 is bonded to the top of the piezoelectric actuator 120 to cover the entire surface thereof, the substrate 330 can be connected to the piezoelectric actuator 120 and the electrode portion 118 while providing superior protection against externals shocks.

As set forth above, according to exemplary embodiments of the invention, an inkjet head, a method of manufacturing the same, and an electrical connection device therefor press a substrate using a bonding tool so as to allow it to be electrically connected to a piezoelectric actuator and an electrode portion arranged in different planes at the same time, thereby simplifying a manufacturing process and preventing electrical bonding failures.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
an inkjet head body having an ink chamber provided therein and an electrode portion provided on a surface thereof adjacent to the ink chamber;
a piezoelectric actuator being mounted on the surface of the inkjet head body so that the piezoelectric actuator is electrically connected to the electrode portion; and
a substrate being pressed using a bonding tool so that the substrate is electrically connected to the electrode portion and the piezoelectric actuator, arranged in different planes, through a conductive adhesive.

2. The inkjet head of claim 1, wherein the conductive adhesive is arranged between the piezoelectric actuator and the substrate and has bent ends making contact with edges of the piezoelectric actuator when the conductive adhesive is pressed at the same time as the substrate is pressed using the bonding tool.

3. The inkjet head of claim 1, wherein the substrate comprises an actuator connection portion electrically connected to one side of the piezoelectric actuator whose other side makes contact with the electrode portion, and electrode connection portions electrically connected to the electrode portion.

4. The inkjet head of claim 3, wherein the actuator connection portion and the electrode connection portions of the substrate are separated from each other.

5. The inkjet head of claim 1, wherein the substrate completely covers a surface of the piezoelectric actuator.

6. The inkjet head of claim 1, wherein the substrate partially covers a surface of the piezoelectric actuator.

7. A method of manufacturing an inkjet head, the method comprising:
arranging an inkjet head body having an electrode portion on a stage;
arranging a piezoelectric actuator on the inkjet head body so that the piezoelectric actuator and the inkjet head body are electrically connected to each other, and arranging the substrate on the piezoelectric actuator; and
pressing the substrate by moving the bonding tool so that the substrate is electrically connected to the piezoelectric actuator and the electrode portion.

8. The method of claim 7, wherein the pressing of the substrate comprises arranging the conductive adhesive under the substrate such that the conductive adhesive is bent in contact with the piezoelectric actuator along the surface thereof.

9. The method of claim 7, further comprising arranging a damper between the substrate and the bonding tool.

10. The method of claim 7, wherein a film type adhesive is used as the conductive adhesive.

11. An electrical connection device for an inkjet head, the electrical connection device comprising:
a stage in which an inkjet head body, having an electrode portion electrically connected with a piezoelectric actuator, is arranged; and
a bonding tool located above the stage and pressing the conductive adhesive and the substrate into close contact with the electrode portion and the piezoelectric actuator arranged in different planes.

12. The electrical connection device of claim 11, wherein the bonding tool further comprises a damper arranged between the conductive adhesive and the bonding tool.

13. The electrical connection device of claim 12; wherein the damper is provided integrally with the bonding tool.

14. The electrical connection device of claim 12, wherein the damper is separated from the bonding tool.

15. The electrical connection device of claim 11, wherein the bonding tool comprises bent portions moving along edges of the piezoelectric actuator.

16. The electrical connection device of claim 11, wherein the stage comprises stoppers to secure the inkjet head body received therein.
